(19) United States
(12) Patent Application Publication
(10) Pub. No.: US 2012/0110235 A1
(43) Pub. Date: May 3, 2012

(54) WIRE CONTROL DEVICE AND ELECTRONIC DEVICE USING THE SAME

(75) Inventors: KUAN-HONG HSIEH, Tu-Cheng (TW); HAN-CHE WANG, Tu-Cheng (TW); CHUN-WEI PAN, Tu-Cheng (TW); GANG WANG, Shenzhen City (CN); WAN-JUN JIANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/095,871

(22) Filed: Apr. 28, 2011

(30) Foreign Application Priority Data
Oct. 29, 2010 (CN) 201010524981.1

(51) Int. Cl. G06F 13/00

(52) U.S. Cl. 710/316

(57) ABSTRACT

A wire control device for wired remotely controlling an electronic device. The wire control device includes a USB connector and a control switch, and the control switch generates control signals. The electronic device includes a USB port and a process unit. When the USB port is connected to the USB connector of the wire control device, the process unit receives the control signals via the USB port and executes corresponding functions.

### BACKGROUND

1. Technical Field

The present disclosure relates to wire control devices and, particularly, to a wire control device for a wired remote control of an electronic device.

2. Description of Related Art

With the development of miniaturization, and the trend towards the portability of electronic devices, a number of functions that are added, such as music, video, e-book reading, to the electronic devices, to make electronic devices user-friendly. In the meantime, adding more functions to the accessories of electronic devices also becomes an increasingly popular trend. However, to achieve complex functions, the accessories often have complex circuits, which will increase the production costs of the accessories.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a wire control device connecting to an electronic reading device, according to a first embodiment.

FIG. 2 is a schematic view of a wire control device connecting to an electronic reading device, according to a second embodiment.

FIG. 3 is a flowchart of a method showing a wire control device wired remote controlling an electronic reading device to flip pages.

### DETAILED DESCRIPTION

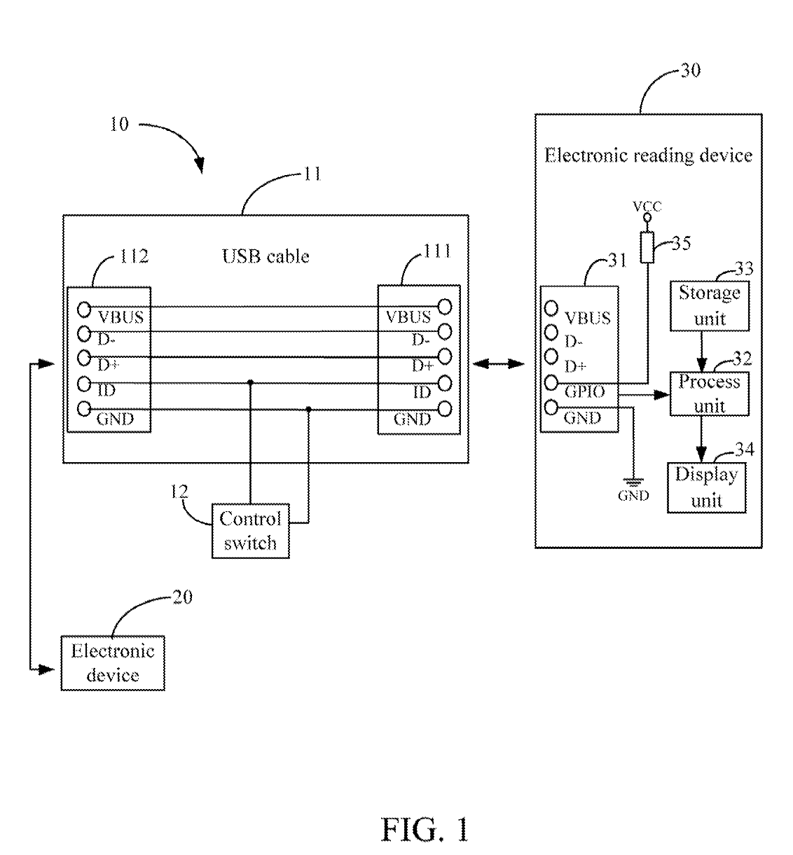

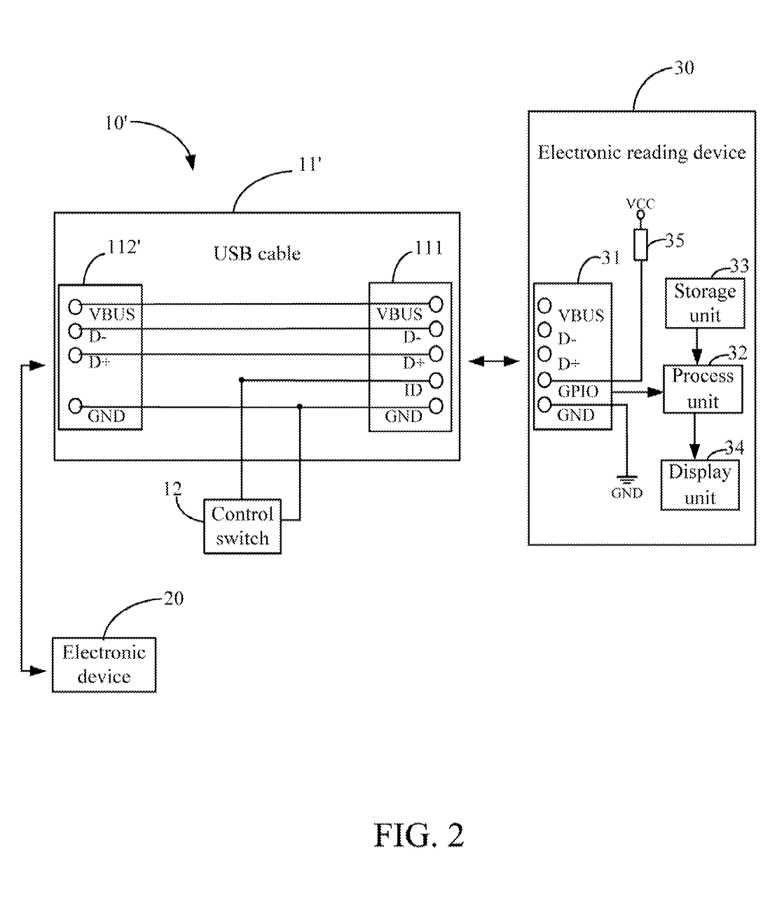

Referring to FIG. 1, a wire control device 10 is configured for wired remote controlling an electronic reading device 30 to flip pages, according to a first embodiment, is illustrated. The wire control device 10 includes a USB cable 11 and a control switch 12 connected to the USB cable 11. The USB cable 11 includes a first USB connector 111 and a second USB connector 112. The USB connectors 111 and 112 both include five pins: a power pin (VBUS), a first data pin (D+), a second data pin (D−), an identification pin (ID), and a ground pin (GND). The five pins of the first USB connector 111 are coupled to corresponding pins of the second USB connector 112, respectively. In an alternative embodiment, as shown in FIG. 2, the second USB connector 112′ of the USB cable 11′ includes four pins: a power pin (VBUS), a first data pin (D+), a second data pin (D−), and a ground pin (GND). The four pins of the second USB connector 112′ are coupled to corresponding pins of the first USB connector 111, respectively, and the ID pin of the first USB connector 111 remains uncoupled to the pins of the second USB connector.

In the embodiment, one terminal of the control switch 12 is connected to the

ID pin of the first USB connector 111, and the other terminal of the control switch 12 is connected to the GND pin of the first USB connector 111. In the embodiment, the control switch 12 is an automatic reset switch, when pressed, the control switch 12 is switched on, and the ID pin and the GND pin of the first USB connector 111 are coupled together by the control switch 12; when released, the control switch 12 is switched off, and the ID pin and the GND pin of the first USB connector 111 are disconnected.

The electronic reading device 30 includes a USB port 31, a process unit 32, a storage unit 33, and a display unit 34. The storage unit 33 stores digital files. The display unit 33 displays the files for users to choose and read. In the embodiment, the USB port 31 mates with the first USB connector 111, and also includes five pins: a power pin (VBUS), a first data pin (D+), a second data pin (D−), a General Purpose Input/Output pin GPIO, and a ground pin (GND). The GPIO pin connects to a power source VCC via a pull-up resistor 34 and obtains a high voltage, the GND pin is grounded.

When the first USB connector 111 of the wire control device 10 (or 10′) connects to the USB port 31, the five pins of the first USB connector 111 are coupled to corresponding pins of the USB port 31, namely the VBUS pin, the D+ pin, the D− pin, the ID pin, and the ground GND of the first USB connector 111 are coupled to the VBUS pin, the D+ pin, the D− pin, the GPIO pin, and the GND pin of the USB port 31, respectively. With such connecting structure, the ID pin of the first USB connector 111 is connected to the GPIO pin of the USB port 31 and obtains a high voltage, the GND pin of the first USB connector 111 is connected to the GND pin of the USB port 31 and obtains a low voltage.

The wire control device 10 (or 10′) can be used in two modes: a data transmission mode and a wired remote control mode. When the second USB connector 112 (or 112′) connects to an electronic device 20, the USB control device 10 (or 10′) is used in the data transmission mode, and the wire control device 10 (or 10′) can transmit data between the electronic device 20 and the electronic reading device 30 via the USB cable 11 (or 11′). When user presses the control switch 12 on the wire control device 10 (or 10′), the USB control device 10 (or 10′) is used in the wired remote control mode, and the control switch 12 generates control signals, and the electronic reading device 30 receives the control signals via the USB port 31 and executes corresponding functions. In the embodiment, the wire control device 10 (or 10′) remotely controls the electronic reading device 30 to flip pages.

In the embodiment, when pressed, the control switch 12 is switched on, and the ID pin of the first USB connector 111 is connected to the GND pin of the first USB connector 111 and obtains a low voltage. Thus, the GPIO pin of the USB port 31 also obtains a low voltage via the ID pin of the first USB connector 111.

The process unit 32 detects the voltage of the GPIO pin of the USB port 31, determines an operation type according to the voltage of the GPIO pin and a duration of the voltage, and executes a corresponding function. In the embodiment, when the control switch 12 is pressed for a first duration t1, namely, the process unit 32 detects that the GPIO pin of the USB port 31 obtains a low voltage, and the first duration t1 falls within a first predetermined time length, such as 2 ms<t1<=10 ms, the process unit 32 flips a page backwards and updates the content on the display unit 33. When the control switch 12 is pressed for a second duration t2, namely, the process unit 32 detects that the GPIO pin of the USB port 31 obtains a low voltage. If the second duration t2 falls within a second predetermined time length, such as 10 ms<t2<=20 ms, the process unit 32 flips a page forward and updates the content on the display unit 33.

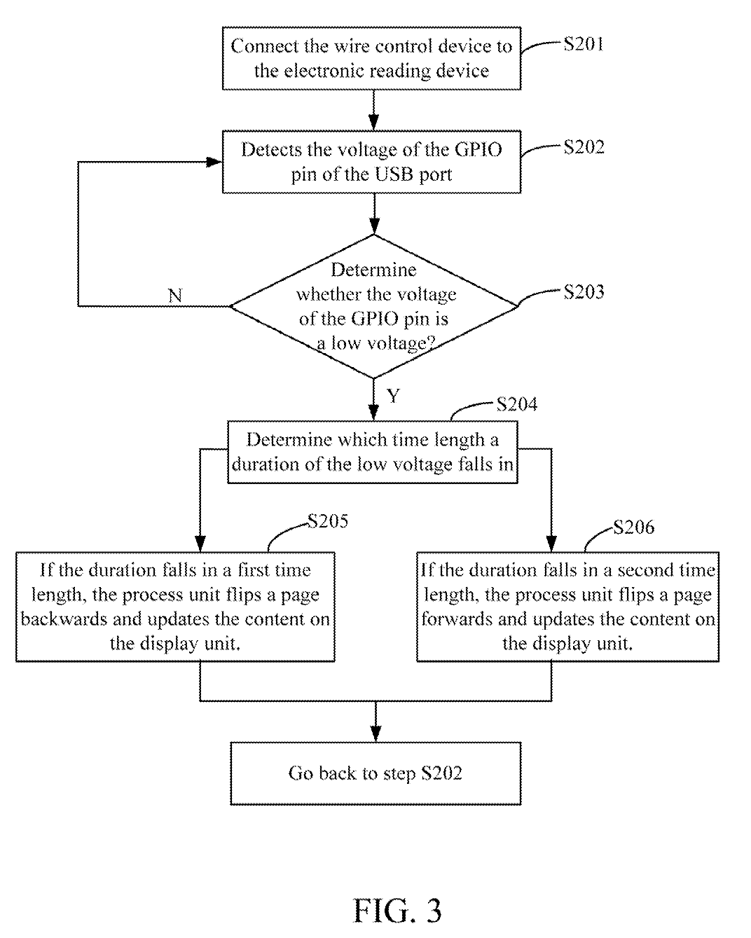

Referring to the FIG. 3, a method showing the wire control device 10 (or 10′) remotely controlling the electronic reading device 30 to flip pages.

In step S201, the electronic reading device 30 connects to the wire control device 10 (or 10′).

In step S202, the process unit 32 detects the voltage of the GPIO pin of the USB port 31.

In step S203, the process unit 32 determines whether the voltage of the GPIO pin is a low voltage?

If the voltage of the GPIO pin is not a low voltage, the procedure goes back to step S202. If the voltage of the GPIO pin is a low voltage, in step S204, the process unit 32 determines which time length the duration of the low voltage falls in.

In step S205, if the duration t falls in the first time length, the process unit 32 flips a page backwards and updates the content on the display unit, and then goes back to step S202.

In step S206, if the duration falls in the second time length, the process unit 32 flips a page forward and updates the content on the display unit 33, and then goes back to step S202.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A wire control device comprising:
a USB cable comprising a first USB connector for connecting a USB port of a first electronic device, the first USB connector comprising five pins: a power pin (VBUS), a first data pin (D+), a second data pin (D−), an identification pin (ID), and a ground pin (GND); and
a control switch connected to the ID pin and the GND pin of the first USB connector, for generating control signals to control the first electronic device to execute corresponding functions.

2. The wire control device as described in claim 1, wherein the control switch is an automatic reset switch, when pressed, the control switch is switched on, and the ID pin and the GND pin of the first USB connector are coupled together by the control switch; when released, the control switch is switched off, and the ID pin and the GND pin of the first USB connector are disconnected.

3. The wire control device as described in claim 1, wherein the USB cable further comprises a second USB connector for connecting a second electronic device, the wire control device transmits data between the first electronic device and the second electronic device via the USB cable.

4. The wire control device as described in claim 3, wherein the second USB connector comprises five pins: a power pin (VBUS), a first data pin (D+), a second data pin (D−), an identification pin (ID), and a ground pin (GND), the five pins of the second USB connector are coupled to corresponding pins of the first USB connector, respectively.

5. The wire control device as described in claim 3, wherein the second USB connector comprises four pins: a power pin (VBUS), a first data pin (D+), a second data pin (D−), and a ground pin (GND), the four pins of the second USB connector are coupled to corresponding pins of the first USB connector, respectively, and the ID pin of the first USB connector remains uncoupled to the pins of the second USB connector.

6. An electronic device, controlled by a wire control device, the wire control device comprising a USB connector and a control switch, wherein the control switch is configured for generating control signals, the electronic device comprising:
a USB port to be connected to the USB connector of the wire control device; and
a process unit to receive the control signals via the USB port and execute functions corresponding to the control signals.

7. The electronic device as described in claim 6, wherein the USB connector comprises five pins: a power pin (VBUS), a first data pin (D+), a second data pin (D−), an identification pin (ID), and a ground pin (GND); the USB port comprises five pins: a power pin (VBUS), a first data pin (D+), a second data pin (D−), a General Purpose Input/Output pin GPIO, and a ground pin (GND), and the five pins of the USB connector are coupled to corresponding pins of the USB port when the USB connector is connected to the USB port.

8. The electronic device as described in claim 7, wherein the GPIO pin of the USB port connects to a power source VCC via a pull-up resistor and obtains a high voltage, the GND pin is grounded.

9. The electronic device as described in claim 8, wherein the control switch is connected to the ID pin and the GND pin of the USB connector, when pressed, the control switch is switched on, and the ID pin of the USB connector is connected to the GND pin of the USB connector and obtains a low voltage, the GPIO pin of the USB port also obtains a low voltage via the ID pin of the USB connector.

10. The electronic device as described in claim 9, wherein the process unit detects the voltage of the GPIO pin of the USB port and a duration of the voltage, and executes a corresponding function.

11. The electronic device as described in claim 10, further comprises a display unit configured for displaying digital files for users to choose and read, wherein when the process unit detects that the GPIO pin of the USB port obtains a low voltage for a first duration, and the first duration falls within a first predetermined time length, the process unit flips a page backwards and updates the content on the display unit; when the process unit detects that the GPIO pin of the USB port obtains a low voltage for a second duration, and the duration falls within a second predetermined time length, the process unit flips a page forward and updates the content on the display unit.

12. An electronic device, comprising:
a wire control device comprising a USB connector and a control switch, wherein the control switch is configured for generating control signals;
a USB port to be connected to the USB connector of the wire control device; and
a process unit to receive the control signals via the USB port and execute functions corresponding to the control signals.

13. The electronic device as described in claim 12, wherein the USB connector comprises five pins: a power pin (VBUS), a first data pin (D+), a second data pin (D−), an identification pin (ID), and a ground pin (GND); the USB port comprises five pins: a power pin (VBUS), a first data pin (D+), a second data pin (D−), a General Purpose Input/Output pin GPIO, and a ground pin (GND), and the five pins of the USB connector are coupled to corresponding pins of the USB port when the USB connector is connected to the USB port.

14. The electronic device as described in claim 13, wherein the GPIO pin of the USB port connects to a power source VCC via a pull-up resistor and obtains a high voltage, the GND pin is grounded.

15. The electronic device as described in claim 14, wherein the control switch is connected to the ID pin and the GND pin of the USB connector, when pressed, the control switch is switched on, and the ID pin of the USB connector is connected to the GND pin of the USB connector and obtains a low voltage, the GPIO pin of the USB port also obtains a low voltage via the ID pin of the USB connector.

16. The electronic device as described in claim 15, wherein the process unit detects the voltage of the GPIO pin of the USB port and a duration of the voltage, and executes a corresponding function.

17. The electronic device as described in claim 16, further comprises a display unit configured for displaying digital files for users to choose and read, wherein when the process unit detects that the GPIO pin of the USB port obtains a low voltage for a first duration, and the first duration falls within a first predetermined time length, the process unit flips a page backwards and updates the content on the display unit; when the process unit detects that the GPIO pin of the USB port obtains a low voltage for a second duration, and the duration falls within a second predetermined time length, the process unit flips a page forward and updates the content on the display unit.

18. The electronic device as described in claim 12, wherein the wire control device further comprises a second USB connector and a USB cable connecting the first USB connector with the second USB connector, the second USB connector is configured for connecting a second electronic device, the wire control device transmits data between the first electronic device and the second electronic device via the USB cable.
